(19) United States
(12) Patent Application Publication
(10) Pub. No.: US 2010/0250444 A1
(43) Pub. Date: Sep. 30, 2010

(54) Reverse selling marketplace

(76) Inventor: Rafi Haun, Boca Raton, FL (US)

Correspondence Address: JanPaul Guzman;Rothstein Rosenfeldt Adler, 401 E. Las Olas Boulevard, Ft. Lauderdale, FL, 33301, US

(21) Appl. No.: 12/383,541

(22) Filed: Mar. 25, 2009

(51) Int. Cl. G06Q 30/00

(52) U.S. Cl. 705/80; 705/26

(57) ABSTRACT

This invention presents a method of matching sellers with buyers in which at least one buyer and one seller register on the Ibuyer website. Each user is then required to create a profile. The method requires a buyer to specify his desires in the form a buying interest and requires a seller to provide an inventory of items. Said buying interest comprises various details regarding an item. Once a user has submitted a buying interest, all the sellers who have items meeting the criteria specified in the buying interest are alerted of a potential buyer. Said sellers then contact the buyer via email, live chat, and submit the item at a price for which the seller will sell the item. Such competition among sellers not only gives sellers a target audience but it also inevitably causes the price to decrease.

### FIELD OF THE INVENTION

The present invention relates generally to the field of e-commerce, and in particular to an on-line reverse selling marketplace that uses an online framework allowing sellers to search for buyers based on the buyer's buying interests and then allows the sellers to compete with one another by being able to view each other's offer; thereby allowing the sellers to offer the buyer the best deal.

### BACKGROUND OF THE INVENTION

With the increase in popularity of the Internet, more and more people are performing commercial activities on-line. Auctions, for example, provide a popular and exiting venue for the buying and selling of goods and services, such as real estate, automobiles, fine art, and other luxury items. However, while many traditional and online bidding systems involve various buyers bidding to purchase a single item resulting in a price that is higher than a buyer would originally have paid if that buyer was not competing with other buyers. The traditional on-line bidding environment involves bidders who register and submit bids through the Internet. Accordingly, various buyers compete among themselves to submit the highest bid to purchase the item. Due to this type of bidding environment the purchasing price inevitably increases forcing consumers to pay a higher price for an item than would have ordinarily been paid.

Moreover, the traditional “want ads,” while allowing a purchaser to specify the desired item, do not create the environment for sellers to compete against one another; thereby offering the purchaser the best deal. The purchaser must, therefore, go back and forth between sellers. This is ineffective and inefficient.

Therefore, what is needed is an online reverse selling marketplace that brings sellers and buyers together based on the buyer's buying interests and the items in the seller's inventory and allows sellers to view the offers made by other sellers to that buyer in an effort to allow sellers to compete for the buyers, by offering the best deal.

### BRIEF DESCRIPTION OF THE DRAWINGS

FIG. 1 is a flow diagram illustrating an embodiment in accordance with the present invention.

FIG. 2 is a flow diagram illustrating an embodiment in accordance with the present invention.

FIG. 3 is a flow diagram illustrating an embodiment in accordance with the present invention.

FIG. 4 is a flow diagram illustrating an embodiment in accordance with the present invention.

### DESCRIPTION OF A PREFERRED EMBODIMENT

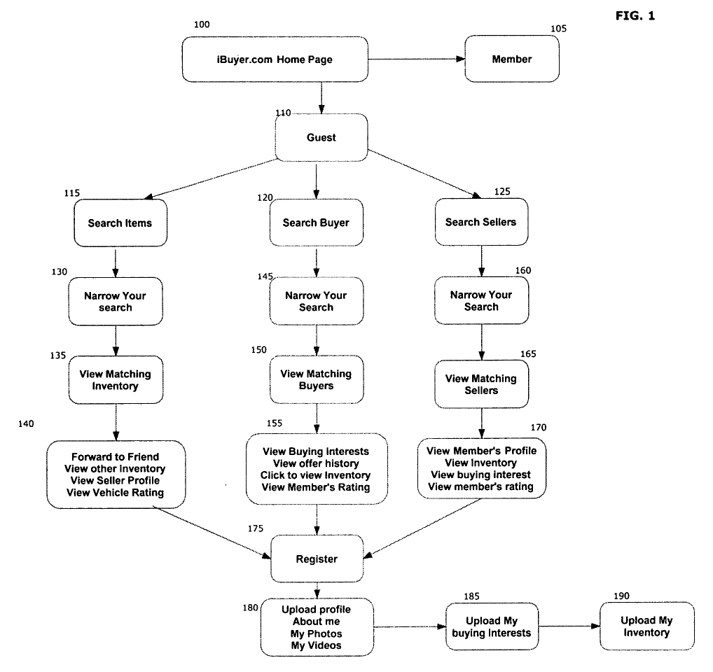

FIGS. 1-4, generally, illustrate the preferred method for bringing sellers and buyers together based on the buyer's buying interests and the items in the seller's inventory and allowing sellers to view the offers made by other sellers to that buyer allowing sellers to compete among one another by offering the buyer the best deal.

Referring to FIG. 1, generally, after a user locates the Ibuyer website 100, the user is presented with the option of logging in as a registered user (“Member”) 105 or using the Ibuyer website 100 as a guest (“Guest”) 110.

As a Guest, the user may browse the Ibuyer website 100 but may only select Search Items 115, Search Buyers 120, and/or Search Sellers 125, which are also available to Members. If the Guest selects the Search Items 115, he is given the option of narrowing his search 130 by entering specific details regarding the item he is interested in purchasing or viewing all the items posted on the Ibuyer website 100. For example, if the Guest is interested in purchasing a vehicle, he will be prompted to enter general information about the vehicle such as the category of the vehicle, including, but not limited to “All Categories,” “Cars & Trucks,” “ATVs,” “Boats,” Buses,” “Commercial Trucks,” “Limousines,” “Military Vehicles,” “Motorcycles,” “PWCs,” “Race Cars,” “RVs & Campers,” or “Everything Else.” The Guest is then prompted to enter specific criteria, such as the year, make, and model, as well as, the preferred body type, mileage, and price of the vehicle. Further, the Guest is given the option of selecting the “Seller Type,” e.g. dealer or private individual, and may enter any other keywords, which he believes may narrow the search. The Guest can also narrow the search by entering the location of the vehicle in terms of miles from his location. After the Guest has entered the search criteria, he can view the results 135 that match with the Inventory of the sellers on the Ibuyer website 100. The Guest may then forward the matches to a friend, view other inventories, view a prospective seller's profile, and/or view the item rating 140.

If the Guest selects Search Buyers 120, he is presented with all the Members who are prospective buyers on the Ibuyer website 100. The Guest may select each Member to determine the item that said Member would like to purchase or the Guest may narrow the search 145 by entering general information about the item that he would like to sell. If, for example, he wanted to sell a vehicle, the Guest would enter the vehicle category, including, but not limited to “All Categories,” “Cars & Trucks,” “ATVs,” “Boats,” “Buses,” “Commercial Trucks,” “Limousines,” “Military Vehicles,” “Motorcycles,” “PWCs,” “Race Cars,” “RVs & Campers,” or “Everything Else,” of the vehicle he wishes to sell. The Guest is then prompted to enter specific criteria, such as, the year, make, and model, as well as, the body type, mileage, and price of the vehicle. Further, the Guest may also select the “Buyer Type,” e.g. dealer or private individual, and may enter any other keywords, which the Guest believes may narrow the search for his item, which in this case is a vehicle. The Guest may also narrow the search by entering the location of the prospective buyer in terms of miles from the Guest's location, as well as whether to limit the search to online buyers only. After entering the inventory criteria, the Guest can view the results that match 150 with the Buyer's Interest(s) 185 of Members on the Ibuyer website 100. The Guest may then view the Member's Buying Interest(s) 185, view the Member's offer histories to determine if a similar vehicle has been offered to that Member and for how much, he can also view the Member's Inventory 190, if any, and view his rating 155.

If the Guest selects Search Sellers 125 he is presented with all the Members, who have uploaded an Inventory 190 and are interested in selling an item on the Ibuyer website 100. The user may select each Member individually and search for the item that Guest would like to purchase or the Guest may narrow the search 160 by entering specific criteria about the desired item. If, for example, the Guest is interested in purchasing a vehicle, he could narrow the search by entering the vehicle category, including, but not limited to “All Categories,” “Cars & Trucks,” “ATVs,” “Boats,” Buses,” “Commercial Trucks,” “Limousines,” “Military Vehicles,” “Motorcycles,” “PWCs,” “Race Cars,” “RVs & Campers,” or “Everything Else,” of the vehicle he wishes to purchase The Guest may then enter other search criteria such as, the year, as well as, the make, model, the preferred body type, mileage, price, and the condition of the vehicle. Further, the Guest is presented with the option of selecting the “Seller Type,” e.g. dealer or private individual, and may enter any other keywords, which he believes may narrow the search. The Guest is also presented with the option of entering the location of the vehicle in terms of miles from the Guest's location, as well as whether to limit the search to online sellers only. After the Guest has entered the search criteria, the Guest can view the results that match 165 with the Members' Inventories 190 on the Ibuyer website 100. The Guest may then view the Member's profile, view the Member's inventory, view the Member's buying interest(s) 185, if any, view the Member's offer history to determine if he has offered said item to another and for what price, and view a Member's rating 170.

As described above, a Guest, may only Search Items 115, Search Buyers 120, and/or Search Sellers 125 on the Ibuyer website 100, but may not communicate with the Members of the Ibuyer Website 100, submit bids to purchase an item, or offer an item for sale.

Therefore, if the Guest does not select to become a Member upon first use of the Ibuyer website 100, the Guest is again prompted to register 175.

To register on the Ibuyer website 100, the user must upload a profile 180 containing a unique individual identifier. The profile 180 may consist of the user's first and last name, the user's email address, date of birth, location, gender, whether the user is a dealer or private individual, a user name, through which the user is to be known, and a password. The user is also given the option of uploading any other information about himself, such as, a photograph, and/or videos. A Member can be both a buyer and a seller.

If the Member is interested in purchasing an item, the Member is then prompted to submit a Buying Interest(s) 185. A Member's Buying Interest(s) 185 describes the type of item in which the Member is interested in purchasing. If, for example, the Member is interested in purchasing an Acura CL that Member's Buying Interest 185 would contain criteria such as 2008-2009 Acura CL hatchback in the price range of $25,000 to $30,000, with mileage between 0-5,000, and black/black, as the colors for the exterior/interior. The Member may also specify that he will only purchase from a dealer or private individual. The Member can also enter specific comments and upload a video describing his buying interests. As discussed above, Member, who is interested in purchasing an item, may submit multiple Buying Interest(s) 185 depending on the number of items that the Member would like to purchase.

If, on the other hand, the Member is interested in selling an item, the Member is prompted to upload a description of this item for sale as his Inventory 190. If, for example, the Member is interested in selling a vehicle the Member must first select a general category describing his vehicle such as, “Cars & Trucks,” “ATVs,” “Boats,” “Buses,” “Commercial Trucks,” “Limousines,” “Military Vehicles,” “Motorcycles,” “PWCs”, “Race Cars,” “RVs”, and, if the vehicle does not fit into one of these categories, the Member may select “Everything Else.” Once the Member, has selected the proper category, he must submit a profile containing identifying information describing his vehicle including, but not limited to, the Vehicle Identification Number (“VIN Number”), the year, make, model, model trim, body type, mileage, exterior color, interior color, type of engine, length of the vehicle, type of fuel required by the vehicle, type of transmission, type of drivetrain of the vehicle, condition of the vehicle, and a price range he is willing to accept for the vehicle. The Member may also submit additional comments, upload photos of the vehicle, and/or upload a video of the vehicle.

In addition to being able to upload a Buying Interest 185 and/or Inventory 190, a Member may participate in the online blogs, forums, and chat rooms.

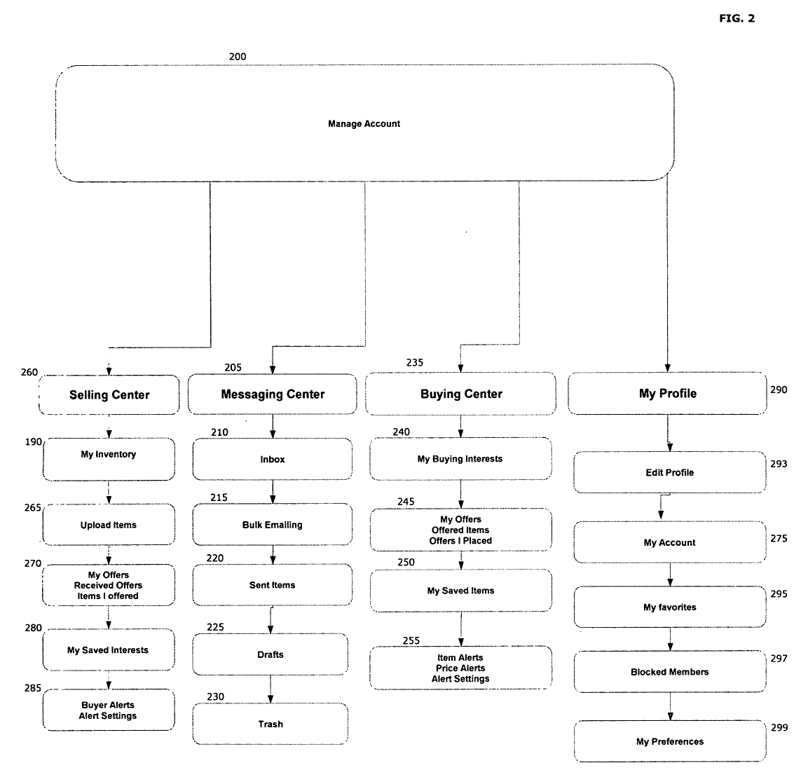

Referring to FIG. 2, generally, a Member of the Ibuyer website 100 has the ability to manage his account by clicking on Manage Account 200. In the section entitled Messaging Center, 205 the Member may view electronic mail (“Email”) or offers received from other Members in his inbox 210. A Member may also compose an Email message(s) to one or more Member(s) in the form of bulk email messaging 215. In addition to Emails, a Member has the ability to send out “bulk” offers from the Messaging Center 205 by choosing contacts from his favorites, choosing an item from his inventory, entering the amount for the item, and submitting the offer to the Members, who are interested in purchasing that particular item. The offer will then go instantly to all the selected Members. The Members can also view sent emails (Sent Items) 220, view email drafts (Drafts) 225, and view emails that have been removed from the inbox, sent items, and/or drafts folder (Trash) 230.

Within the section entitled Buying Center, 235 the Member can select My Buying Interests 240, My Offers 245, My Saved Items 250, and Item Alerts 255. In My Buying Interest 240, the Member may add new Buying Interest(s) 185 or he may modify or delete an existing Buying Interest 185. Within the section entitled My Offers 245, the Member will receive all offers for items submitted by other Member(s). Additionally, within My Offers 245 the Member will be allowed to view and respond to all offers said Member has submitted. By selecting My Saved Items 250 the Member can view the items that he has saved by conducting searches on the Ibuyer Search Items 115 section. Additionally, under Item Alerts 255, the Member can add, modify, and/or delete an item alert, price alert, or an alert setting. Through an Item Alert 255 the Member will receive an alert if an item matching his Buying Interest(s) 185 is added to or removed from the Ibuyer website 100. Through a price alert the Member will receive an alert if the price of an item matching his Buying Interest(s) 185 or that is being offered to him is modified. Further, the Member can modify or delete alert criteria through the manage alerts. An Item Alert 255 allows a Member to be notified via email or wireless short message service, as well as through his alerts either in the Buying Center 235 or in the Selling Center 260, if and when a item matching his buying interest(s) is added to the Ibuyer website 100 or the price on an offered item matching his Buying Interest(s) 185 is modified. Price Alerts 255 will entice the Members to negotiate.

Within the section entitled Selling Center 260, the Member may modify or delete an item in his Inventory 190, upload additional items by selecting Upload Items 265, view offers by selecting My Offers 270, view other Saved Interests 280 and view and manage the Buyer Alerts 285.

Within My Offers 270, the Member is able to view all offers made by other Members for items in his Inventory 190 and can view all offers and responses to all offers he has made to and received from other Members. By selecting My Saved Interests 280 the Member can view the Buying Interest(s) 185 of other Members that he has saved by conducting searches by selecting Search Buyer 120.

Within Buyer Alerts 285, the Member will receive all alerts via email, wireless short message service, as well as his Messaging Center, if another Member's Buying Interest(s) 185 has been added or modified and now matches an item in his Inventory 190. The Member can also modify or delete alert criteria.

The section entitled My Profile 290 comprises the folders Edit Profile 293, which allows the Member to edit his profile 180. The Member may also modify account information, such as his email and/or password by selecting My Account 275. The Member may view or delete other Members he has selected as his favorite friends, favorite buyers, and favorite sellers, or all three, by selecting by selecting My Favorites 295. By selecting the Blocked Members 297 option, the Member can view the Members who he has blocked and unblock them from the blocked Member list. The Member can also, view his preferences by selecting the My Preferences 299.

Once the Member has completed setting up the user account, any user, Guest or Member, may search his Buying Interest(s) 185 and/or his Inventory 190. However, only a Member may contact other Members who are interested in purchasing or selling an item.

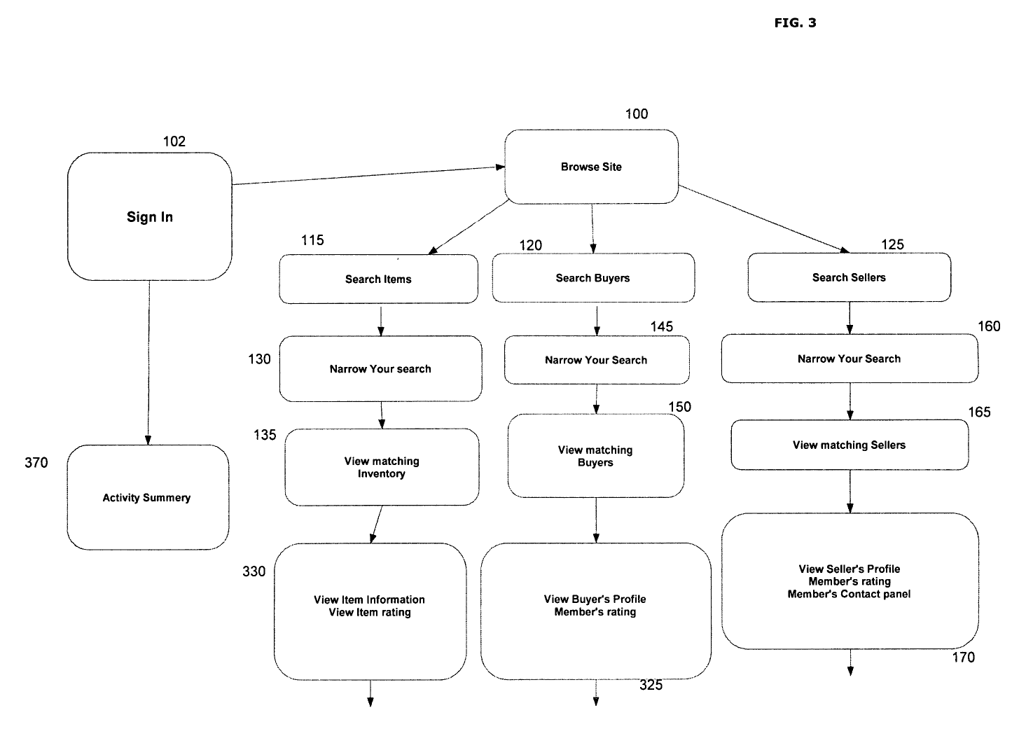

Referring to FIG. 3, generally, if the user has previously become a Member of the Ibuyer website 100 he simply needs to enter his user name and password to Sign In 102. Once the Member has signed in, he may browse the Ibuyer website 100 or view his Activity Summary 370, showing user his new message in his Messaging Center 205, Buying Center 235, and Selling Center 260. The Activity Summary 370 will also show the current number of favorite buyers, sellers, and friends of said Member and the current number of Blocked Members 297.

Upon selecting Search Buyers 120 the Member is presented with each Member, who is interested in purchasing an item on the Ibuyer website 100 from which to select. The Member may select each Member, who is interested in purchasing an item, to determine the item that the Member is seeking to purchase or the Member may narrow the search 145 by specifying the criteria of items in his Inventory 190 to find specific buyers. If, for example, the Member is interested in selling a vehicle, he would specify certain criteria such as the vehicle category, e.g. “All Categories,” “Cars & Trucks,” “ATVs,” “Boats,” Buses,” “Commercial Trucks,” “Limousines,” “Military Vehicles,” “Motorcycles,” “PWCs,” “Race Cars,” “RVs & Campers,” or “Everything Else.” The Member may then enter the year, the make, model, body type, as well as, the mileage, price, and the condition of the vehicle. Further, the Member can select the “Buyer Type,” e.g. dealer or private individual and may enter any other keywords, which the Member believes may narrow the search for prospective buyers. The Member is also presented with the option of entering the location of the prospective buyer in terms of miles from the Member's location, as well as whether to limit the search to online users only. After the Member has entered the criteria describing item(s) in this Inventory 190 and has been matched with other Member's Buying Interest(s) 185, the Member may view and/or contact the Members with matching Buying Interests 185. The Member may then view profile of the Member(s) 180 with matching buying interest(s) 185 or view his member rating 325.

If the Member selects Search Sellers 125 he is presented with all the Members interested in selling an item on the Ibuyer website 100. The Member may select each Member interested in selling an item(s) on the Ibuyer website 100 or the Member may narrow the search 160 for a particular item. If, for example, the Member is interested purchasing a vehicle, he can narrow the search 160 by entering the category of the vehicle he is interested in purchasing, such as “All Categories,” “Cars & Trucks,” “ATVs,” “Boats,” Buses,” “Commercial Trucks,” “Limousines,” “Military Vehicles,” “Motorcycles,” “PWCs,” “Race Cars,” “RVs & Campers,” or “Everything Else.” The Member may then other descriptive criteria enter the year, as well as, the make, model, body type, mileage, price, and the condition of the vehicle. Further, the Member is also presented with the option of selecting the “Seller Type,” e.g. dealer or private individual, and may enter any other keywords, which Member believes may narrow the search. The Member is also presented with the option of entering the location of the vehicle in terms of miles from the Member's location, as well as whether to limit the search to online sellers only. After the Member has entered the search criteria, the Member can select the other Members with item(s) in their Inventory(s) 190 that match the prospective buyer's Buying Interest(s) 185. The Member may then view the Member's profile, the Member's rating 170, or the Seller's Contact Panel.

If the Member selects Search Items 115, he is given the option of narrowing his search 130 by entering specific details regarding the item he is interested in purchasing or viewing all the items posted on the Ibuyer website 100. For example, if the Member is interested in purchasing a vehicle, he will be prompted to enter general information about the vehicle such as the category of the vehicle, including, but not limited to “All Categories,” “Cars & Trucks,” “ATVs,” “Boats,” Buses,” “Commercial Trucks,” “Limousines,” “Military Vehicles,” “Motorcycles,” “PWCs,” “Race Cars,” “RVs & Campers,” or “Everything Else.” The Member is then prompted to enter specific criteria, such as the year, make, and model, as well as, the preferred body type, mileage, and price of the vehicle. Further, the Member is given the option of selecting the “Seller Type,” e.g. dealer or private individual, and may enter any other keywords, which he believes may narrow the search. The Member can also narrow the search 130 by entering the location of the vehicle in terms of miles from his location. After the Member has entered the search criteria, he can view the Member(s) with matching items 135 in their Inventory 190. The Member can then view additional information regarding the item or view the item rating 330.

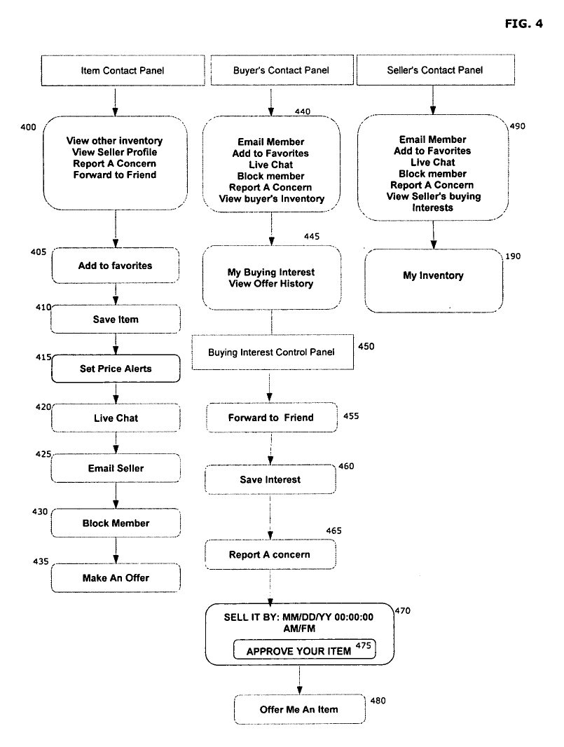

Referring the FIG. 4, generally, each Member, whether a seller and/or a buyer has either an Item Contact Panel 400, a Buyer's Contact Panel 440, or a Seller's Contact Panel 490 depending on whether the Member is a seller for one item and a buyer for another. Once the Member has been matched with a correlating Buying Interest 185 or Inventory 190, he may select the corresponding Item Contact Panel 400, the Buyers Contact Panel 440 or Seller's Contact Panel 490.

If the Member is matched with a correlating Buying Interest 185, he may select the corresponding Buyers Contact Panel 440. Within the Buyer's Contact Panel 440, the Member may email the prospective buyer 425, select Live Chat 420 to instantly communicate with the prospective buyer, select Report A Concern 465 to report a concern about an item or about a Member to the webmaster, select Add to Favorites 405 to add that Member as a friend, a seller, a buyer, or all three, view buyer's additional Buying Interest(s) 185, or prevent any communications from another Member.

If the Member's Buying Interest 185 is matched with a correlating Inventory 190, he may select the corresponding Item Contact Panel 400. Within the Item Contact Panel 400, the Member may select to add that seller as a friend, a seller, a buyer, or all three 405, he may then forward the matches to a friend, view other inventories of that specific seller who is selling the vehicle, view the seller's profile, report a concern, Set Price Alerts 415, as described above, Make An Offer 435 to invite the registered seller to commence negotiating with the registered buyer, Live Chat 420 to instantly communicate with the seller, Save Item 410, Email Seller 425, or Block Seller 430.

Once the Member clicks Make An Offer 435 from the Seller's Contact Panel 400 the offer is then sent to My Offers 270. The seller can then reply by accepting, declining, requesting additional information or making a counter-offer. Subsequently, the offer is returned to the buyer's My Offers 245 and the buyer can respond by clicking accept, decline, retract, comment, or counteroffer. However, before either the seller or the buyer can submit a response, the offer must first be verified as being current and has not been retracted or modified by the seller prior to the buyer's response. If the offer has been modified the buyer will be notified of such modification and asked if he would like to continue with his selection or see the modified offer and modify his selection accordingly. If the offer has been modified prior to the buyer's response, the buyer will be notified of such action and the buyer will not be allowed to submit a response. If the offer is still current at the time of response, the negotiation between the buyer and the seller will continue until either the buyer and seller reach an agreement or the offer is declined.

As discussed above, the Buyer's Contact Panel 440 also allows a Member interested in selling an item to view another Member's Buying Interest(s) 185, if any, as well as that Member's offer history 445. While viewing the other Member's Buying Interest(s) 185 and offer history 445, the Member is presented with a Buying Interest Contact Panel 450, which allows the user, Guest or Member, to forward the Member's information to a friend 455. The Buying Interest Contact Panel 450 also allows a Member to select Save Interest 460 allowing that Member to save the Buying Interest 185 in his account. The Guest or Member can also select Report a Concern 465 to report a concern about an item or about the member to the webmaster. The Member can select Offer Me An Item 480, inviting a Member interested in selling an item to offer the item to the buyer for a specific amount. Once the Member clicks Offer Me An Item 480, if Member does not have an item in his inventory 190 that meets the Member's Buying Interest 185 the system will not allow the Member to offer an item. If the Member has an item in his inventory 190 that matches the Buying Interest(s) 185, the Member will be required to select the item from his Inventory 190, enter the offer amount within the prospective buyer's specified price range, and any comments and click send. The offer is then sent to the prospective buyer's My Offers 245, where he can see who it came from, the offer amount, the time, and the vehicle. The buyer can then reply to the offer by clicking accept, decline, comment, or counteroffer. However, before the buyer can submit a response, the offer must first be verified as being current and has not been modified by the seller prior to the buyer's response. If the offer has been modified the buyer will be notified of such action and asked to refresh his webpage to see the modified offer and modify continue accordingly. If the offer is current and the prospective buyer submits a counteroffer, said counteroffer is sent back to the seller's My Offers 270 for the seller to respond by clicking accept, decline, retract, comment, or counteroffer. This negotiation will continue until either the buyer and seller reach an agreement or the offer is declined.

By accessing the Offer History 445 the Member interested in selling an item can view other offers made to the prospective purchaser to determine if other Members have offered similar items to that prospective purchaser and for how much. If the Member wishes to sell the item to the prospective purchaser, his offer must be better than the last offer made. The fact that the Members can view the offer histories allows them to compete among one another to offer the prospective purchaser the best deal.

Within the Buying Interest Contact Panel 440, the Member who is interested in purchasing a certain item can select Sell it By 470 function and commit to buying the lowest price item on a certain date. A Member may choose the Sell it By 470 feature at the time he is entering his Buying Interest(s) 185 or after he has already listed his Buying Interest(s) 185. To utilize the Sell it By 470 feature, the buyer must first choose a length of time for Members who have an item in their inventory 190 matching the buying interest 185 to submit an offer. For example, the buyer may choose to keep the time available to make an offer open for 7 days, 14 days, 21 days, or 30 days. The buyer can also specify a maximum bid to restrict the Members with matching items from submitting offers for more than a certain amount. Once the Sell it By 470 feature is activated, a date and time will be displayed in his buying interest window along with a clock measuring the time until the end of the auction and the maximum bid if specified.

However, Members, interested in submitting a bid must first request that the purchaser approve the item in the Member's Inventory 190. For the prospective purchaser to approve the item in the Member's Inventory 190, the Member, wishing to submit the item for a bid must select Approve My Item 475. After the Member clicks on Approve My Item 475, the Ibuyer system will check the Member's inventory for an Item matching the buying interest 185. If a match is not found the Member will not be able to submit his item for approval, if an item matching the Buying Interest 185 is found, the Member with the item will be requested to choose the matching item from his inventory, enter an amount and enter comments if any. If the Member specified a maximum bid in his Buying Interest 185, the Member submitting the bid will be promoted to enter an amount that is equal or lower than the maximum bid. However, if the Member did not specify a maximum bid in his Buying Interest 185 the Member will be prompted to enter any amount. After the bid is submitted, the Member will receive a notification that bid was delivered. The bid will be sent to the Member's Offered Items 245, where the Member will either accept or reject the item.

If the Member rejects the item, the selling Member will receive a notification to his Items I Offered 270 notifying said selling Member that the item did not get approved. If, however, the buying Member approves the item, the selling Member will receive a notification to his Items I Offered 270 alerting him that his item was approved for this auction and that he is currently the lowest bid. The Members who have already been approved may continue to submit new, lower offers by entering the offer amount and selecting Make An Offer 435.

If either the prospective purchaser of the Member with the item reject either the offer or counter-offer, the item is removed from the auction and will also be removed from the offer history.

All approved bids will be displayed in the offer history. If a new bid is approved and becomes the lowest bid all other participating Members will receive an email via email or wireless short message service, as well as through his Messaging Center, informing them of a new lowest bidder and the amount.

Once the time has expired, the lowest bid will automatically be accepted by the prospective purchaser, and the Member, who submitted the lowest bid, will be notified via email or wireless short message service, as well as through his Messaging Center, that his bid has been accepted.

After the lowest bid has been accepted all other Members submitting bids will be notified via email or wireless short message service, as well as through his Messaging Center, that their respective offers have been declined and are no longer valid.

In view of Applicant's teachings, many embodiments of the current invention are possible. For example, one alternative embodiment of Applicant's reverse selling marketplace may allow the Members to bid against one another as directed to a particular item in a Member's inventory. Another embodiment may allow Members to bid against one another for the buying interests associated with a particular registered buyer. Practically any combination of selling and buying can be represented using the principles set forth in this description of the instant invention.

It will be appreciated by persons of ordinary skill in the art that various embodiments of the present invention are not limited to what has been particularly shown and described herein above. One of ordinary skill in the art will appreciate, based on Applicant's teachings, that other goods and services may be offered in the reverse selling marketplace without deviating from Applicant's invention. A variety of modifications and variations are possible in light of the above teachings without departing from the scope and spirit of the invention, which is limited only by the following claims.

What is claimed is:

1. A method of matching sellers with buyers comprising the steps of:
registering at least two users where at least one user is a buyer and at least one user is a seller;
requiring each of the at least two users to create a profile;
searching a buying interest in a profile of the buyer based on an inventory specified in a profile of the seller; and
matching the seller with the at least one buyer by correlating the inventory from the profile of the seller with the buying interests from the profile of the buyer.

2. The method according to claim 1 wherein the seller sends an offer to the buyer.

3. The method according to claim 2 wherein the seller modifies the offer.

4. The method according to claim 2 wherein the offer conforms to the buying interests of the buyer.

5. The method according to claim 4 wherein the offer comprises of the goods existing in the inventory of the seller for a specified price.

6. The method according to claim 4 wherein the offer comprises of the services existing in the inventory of the seller for a specified price.

7. The method according to claim 2 further comprising the step of: notifying the buyer of the offer.

8. The method according to claim 2 further comprising the step of: responding to the offer.

9. The method of claim 8 wherein responding to the offer comprises selecting a response from at least one of accepting the offer, declining the offer, requesting additional information about the offer, submitting a counteroffer, and optionally including comments with at least one response, wherein the offer is verified as being current before submitting the response.

10. The method according to claim 9 wherein responding to the offer comprises retracting the counteroffer when the counteroffer is verified as being current.

11. The method according to claim 2 wherein the seller retracts the offer.

12. The method according to claim 9 wherein declining the offer comprises terminating a conversation relating to the offer.

13. The method according to claim 9 wherein selecting accepting the offer sends an alert to the buyer and to the seller notifying each of acceptance of the offer.

14. The method according to claim 12 wherein selecting declining the offer sends an alert to the buyer and to the seller notifying each of that the offer has been declined and a conversation relating to the declined offer is terminated.

15. The method according to claim 9 wherein selecting requesting additional information sends an alert to the seller requesting additional information.

16. The method according to claim 9 wherein selecting submitting a counteroffer sends an alert to the seller notifying the seller of the counteroffer.

17. The method according to claim 1 wherein the identity of the buyer may be withheld from the seller.

18. The method according to claim 1 wherein the identity of the seller may be withheld from the buyer.

19. The method according to claim 1 wherein the at least one buyer may alert the seller of an interest in an item existing in the inventory of the seller.

20. The method of claim 19 wherein alerting the seller comprises selecting at least one of informing the seller that the buyer is interested in the item, would like the seller to send the buyer an offer, requesting if the price is negotiable, and requesting additional information about the item.

21. The method according to claim 2 wherein the seller cannot send the offer to the buyer if the seller does not have an item in his inventory that correlates with the buyer's buying interests.

22. The method according to claim 2 wherein the seller sends the buyer an offer when seller has an item in his inventory that correlates with the buyer's buying interests, the offer comprising and amount within the buyer's specified price range, and optional comments.

23. The method according to claim 1 wherein the seller can view a history of offers sent to the buyer.

24. A method of matching sellers with buyers comprising the steps of:
registering at least two users where at least one user is a buyer and at least one user is a seller;
requiring each of the at least two users to create a profile;
searching a buying interest in a profile of the buyer based on an inventory specified in a profile of the seller;
matching the seller with the at least one buyer by correlating the inventory from the profile of the seller with the buying interests from the profile of the buyer; and
alerting the seller of a buying interest in a profile of the buyer that correlates to at least one item in the inventory from the profile of the seller.

25. The method according to claim 24 wherein the seller sends an offer to the buyer.

26. The method of claim 24 wherein responding to the offer comprises selecting a response from at least one of accepting the offer, declining the offer, requesting additional information about the offer, submitting a counteroffer, and optionally including comments with at least one response, wherein the offer is verified as being current before submitting the response.

27. The method according to claim 26 wherein responding to the offer comprises retracting the counteroffer when the counteroffer is verified as being current.

28. The method according to claim 26 wherein the seller retracts the offer.

29. The method according to claim 26 wherein declining the offer comprises terminating a conversation relating to the offer sent by the seller.

30. The method according to claim 26 wherein selecting accepting the offer sends an alert to the buyer and to the seller notifying each of acceptance of the offer.

31. The method according to claim 26 wherein selecting declining the offer sends an alert to the buyer and to the seller notifying each of that the offer has been declined and a conversation relating to the declined offer is terminated.

32. The method according to claim 26 wherein selecting requesting additional information sends an alert to the seller requesting additional information.

33. The method according to claim 26 wherein selecting submitting a counteroffer sends an alert to the seller notifying the seller of the counteroffer.

34. The method according to claim 24 wherein the identity of the buyer may be withheld from the seller.

35. The method according to claim 24 wherein the identity of the seller may be withheld from the buyer.

36. The method of claim 24 wherein alerting the seller comprises selecting at least one of informing the seller that the buyer is interested in the item and would like the seller to send the buyer an offer, requesting if the price is negotiable, and requesting additional information about the item.

37. A method of matching sellers with buyers comprising the steps of:
registering at least two users where at least one user is a buyer and at least one user is a seller;
requiring each of the at least two users to create a profile;
searching a buying interest in the profile of the buyer based on an inventory specified in a profile of the seller;
matching the seller with the at least one buyer by correlating the inventory from the profile of the seller with the buying interests from the profile of the buyer;
alerting the seller of a buying interest in a profile of the buyer that correlates to at least one item in the inventory from the profile of the seller;
sending an offer to the buyer with buying interests that conform with the inventory from the profile of the seller;
responding to the offer comprises selecting a response from at least one of accepting the offer, declining the offer, requesting additional information about the offer, submitting a counteroffer, and optionally including comments with at least one response, wherein the offer is verified as being current before submitting the response;
keeping the identify of at least one buyer from the at least one seller; and
keeping the identity of at least on seller from at least one buyer.

38. The method according to claim 37 wherein responding to the offer comprises retracting the counteroffer when the counteroffer is verified as being current.

39. The method according to claim 37 wherein the seller retracts the offer.

40. The method according to claim 37 wherein declining the offer comprises terminating a conversation relating to the offer sent by the seller.

41. The method according to claim 37 wherein selecting accepting the offer sends an alert to the buyer and to the seller notifying each of acceptance of the offer.

42. The method according to claim 37 wherein selecting declining the offer sends an alert to the buyer and to the seller notifying each of that the offer has been declined and a conversation relating to the declined offer is terminated.

43. The method according to claim 37 wherein selecting requesting additional information sends an alert to the seller requesting additional information.

44. The method according to claim 37 wherein selecting submitting a counteroffer sends an alert to the seller notifying the seller of the counteroffer.

45. A method of matching sellers with buyers comprising the steps of:
registering at least two users where at least one user is a buyer and at least one user is a seller;
requiring each of the at least two users to create a profile;
searching a buying interest in the profile of the buyer based on an inventory specified in a profile of the seller;
requiring the buying interest to specify the date by which the purchase will be completed;
matching the inventory of the at least one seller to the buying interests of the buyer;
sending a notification to the buyer notifying said buyer that the at least one seller has at least one item matching said buying interest;
requiring the buyer to choose at least one seller to participate in the reverse bidding marketplace;
requiring the at least one seller to submit an offer;
allowing the at least one seller to view the offers made by other sellers; and
requiring the buyer to accept the item offered at the lowest price.

46. The method according to claim 45 further comprising the step of: responding to the offer.

47. The method according to claim 46 wherein responding to the offer comprises selecting a response from at least one of accepting the offer, declining the offer, requesting additional information about the offer, submitting a counteroffer, and optionally including comments with at least one response, wherein the offer is verified as being current before submitting the response;

48. The method according to claim 47 wherein accepting the offer sends an alert to the buyer and to the seller notifying each of acceptance of the offer.

49. The method according to claim 47 wherein accepting the offer sends an alert to the sellers notifying each that the offer has been declined and a conversation relating to the declined offer is terminated.
